(19) United States
(12) Patent Application Publication
(10) Pub. No.: US 2023/0074139 A1
(43) Pub. Date: Mar. 9, 2023

(54) PROACTIVE MAINTENANCE FOR SMART VEHICLE

(71) Applicant: International Business Machines Corporation, Armonk, NY (US)

(72) Inventors: Partho Ghosh, Kolkata (IN); Venkata Sathyadeva Sainadha Krishna Chikka, Visakhapatnam (IN)

(21) Appl. No.: 17/465,989

(22) Filed: Sep. 3, 2021

(51) Int. Cl. G07C 5/00; G07C 5/02; G07C 5/10; G09B 19/00

(52) U.S. Cl. CPC G07C 5/006; G07C 5/02; G07C 5/10; G09B 19/003

(57) ABSTRACT

A processor may receive an input dataset. The input dataset may be associated with a plurality of vehicle components and one or more performance factors of the recreational vehicle. A processor may generate a digital twin of the recreational vehicle using the input dataset. A processor may simulate, using the digital twin, an impact of one or more conditions on the recreational vehicle. The simulating may include a prediction having one or more predicted conditions associated with the recreational vehicle.

### BACKGROUND

The present disclosure relates generally to the field of vehicle management, and more particularly to identifying conditions or potential damage associated with a vehicle.

Often, vehicles that are not actively maintained or managed can lead to vehicle inefficiency or even vehicle breakdown. One significant contributing factor to vehicle damage is the failure of one or more systems of the vehicle resulting from routine use. As such, vehicles need to be continuously maintained to combat potential breakdown and damage.

### SUMMARY

Embodiments of the present disclosure include a method, computer program product, and system for proactive recreational vehicle maintenance. A processor may receive an input dataset. The input dataset may be associated with a plurality of vehicle components and one or more performance factors of the recreational vehicle. A processor may generate a digital twin of the recreational vehicle using the input dataset. A processor may simulate, using the digital twin, an impact of one or more conditions on the recreational vehicle. The simulating may include a prediction having one or more predicted conditions associated with the recreational vehicle.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram of an embodiment of a computing environment for generating, modeling, and/or simulating a digital twin in accordance with the present disclosure.

FIG. 2 illustrates a flowchart of a method for managing a recreational vehicle, in accordance with embodiments of the present disclosure.

FIG. 3 illustrates a flowchart of a method for managing a recreational vehicle, in accordance with embodiments of the present disclosure.

FIG. 4 illustrates a flowchart of a method for managing a recreational vehicle, in accordance with embodiments of the present disclosure.

FIG. 5A illustrates a cloud computing environment, in accordance with embodiments of the present disclosure.

FIG. 5B illustrates abstraction model layers, in accordance with embodiments of the present disclosure.

FIG. 6 illustrates a high-level block diagram of an example computer system that may be used in implementing one or more of the methods, tools, and modules, and any related functions, described herein, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of vehicle management, and more particularly to identifying conditions or potential damage associated with vehicle usage. Embodiments contemplated herein utilize digital twin technology to form predictive vehicle conditions for different motor vehicles, such as recreational vehicles. While the present disclosure is not necessarily limited to such applications, various aspects of the disclosure may be appreciated through a discussion of several examples using this context.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

It will be readily understood that the instant components, as generally described and illustrated in the figures herein, may be arranged and designed in a wide variety of different configurations. Accordingly, the following detailed description of the embodiments of at least one of a method, apparatus, non-transitory computer readable medium and system, as represented in the attached figures, is not intended to limit the scope of the application as claimed but is merely representative of selected embodiments.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Accordingly, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the FIGS., any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application and to enable others of ordinary skill in the art to understand the disclosure for various embodiments with various modifications as are suited to the particular use contemplated.

Motor vehicles play an obvious key role in people's day to day lives by allowing not only people, but various objects to be transported to different locations. Over time people have configured motor vehicles in various ways to allow them to overcome different travel obstacles and/or landscapes. For example, some motor vehicles, such as recreational vehicles, have evolved over time to address various obstacles such as including, but not limited to, having living quarters and the ability to seamlessly traverse various environments. Recreational vehicles may include, but are not limited to campers, trailers, amphibious vehicles, houseboats, and/or motorhomes. Due to the often complex systems, recreational vehicles allow users to perform activities traditional motor vehicles are incapable of performing. In one example, an amphibious recreational vehicle combines not only vehicle systems required to travers land, but also various boating systems. Such systems must work in a concerted manner for the amphibious vehicle to effectively transform from a land based vehicle to a water based vehicle. In another example, a motorhome may include a variety of systems, including, but not limited to, waterpipe systems, septic systems, electrical systems, ventilation systems, hydraulic and braking systems.

As with any vehicle, usage of the recreational vehicle under various conditions can lead to one or more vehicle components of the various systems to wear and breakdown. In some situations, the one or more conditions may be severe enough to affect the integrity of the recreational vehicle and create a dangerous situation for users occupying the vehicle. While some vehicles may include some built in self tests (BISTs) associated with particular vehicle components, many recreational vehicles may require a person specializing in the particular recreational vehicle to identify vehicle components requiring repair or replacement. Even when a person specializing in the particular recreational vehicle type performs routine maintenance, due to the complexity and general lack of visibility of some systems or system subcomponents, it may be difficult to for the person to predict how the vehicle components may perform over time under different conditions (e.g., changes in the environment), what vehicle components may require maintenance in the future, and predicting how long a vehicle component may allow the vehicle to operate as intended. As such, vehicle components in need of that may warn of accuracy in weather forecasting has improved, the severity of a storm or weather condition and resulting impact on a vehicle or shelter can be difficult to predict.

While some system failures may be minimal in nature and allow the person time to seek a remedy to the issue the functionality of the vehicle, other failures may result in the However, due to the unique nature of recreational vehicles, often such failures or breakdowns occur when the vehicle is in use when access to maintenance or aid is hard to find. For example, an amphibious vehicle, used to traverse a lake, may breakdown and become inoperable in the middle of the lake. Such a breakdown may not only result in a significant expense to the user for the inoperable recreational vehicle to be transported to a place where the necessary maintenance may be performed, but also increased downtime of the vehicle. As such, a method of predicting and managing the maintenance of a recreational vehicle breakdown is desired.

As such, the present disclosure provides embodiments associated with managing and simulating a recreational leveraging an artificial intelligence enabled digital twin simulation engine to simulate a recreational vehicle. A digital twin may be generated to simulate a particular recreational vehicle and take into consideration various factors and conditions of the recreational vehicle including, simulation results associated with detecting anomalies, predicting damage (e.g., water quality, pattern of scaling, rusting, blockages or jams in the valves or pipes, and weakening in one or more of the plurality of vehicle components) to one or more vehicle components, identifying why one or more damage/faults/defects of the recreational vehicle may be occurring, determining if the predicted damage requires maintenance to mitigate the predicted damage, and determining the duration of time the system may be operated before one or more subcomponents (e.g., recreational vehicle components 116) fails to perform as intended and/or the entire system fails. In addition, the digital twin simulation engine can also simulate how the water and/or other liquids associated with the recreational vehicle might be used efficiently during operation of the recreational vehicle. A recreational vehicle management system, such as discussed herein, may also be employed for other uses, (e.g., first responders can receive relevant information about the recreational vehicle (e.g., firetruck) and people in the vehicle. Such systems may also be configured to monitor the recreational vehicle's surrounding environment (e.g., particular terrain, particular weather conditions, proximity to bodies of water, etc.).

The following disclosure provides various embodiments for a recreational vehicle management system that may leverage the use of digital twin technology to improve the management of vehicles, particularly in regard to how conditions may impact the vehicle. In embodiments, an input dataset comprising data associated with the vehicle system may be received by a processor. The input dataset may include information about the plurality of vehicle components (e.g., materials associated with the vehicle structure, various systems and subsystem components of the recreational vehicle, etc.) that make up the composition/structure of the recreational vehicle and one or more performance factors (environmental factors, material parameters, etc.). In embodiments, a digital twin of the recreational vehicle is generated using information and data associated with the input dataset. A generated digital twin of the recreational vehicle can simulate one or more features of the recreational vehicle and generate a prediction having one or more predicted conditions associated with the recreational vehicle.

A prediction may include, but is not limited to, one or more recommended actions, one or more recommended vehicle maintenance plans, and in response to identifying one or more predicted conditions, recommending repairs to the recreational vehicle, recommended maintenance schedules (e.g., when inhabitants/users/people using the vehicle will be least affected), operating conditions or performance factors associated with the particular condition, and further recommendations for improving the overall health and longevity of the recreational vehicle during various modes of operation or working conditions. Using digital twin technology can address the various other problems associated with traditional recreational vehicles, while also improving space and facility utilization, optimize accounting associated with recreational vehicles, and scale enterprises that utilize recreational vehicles.

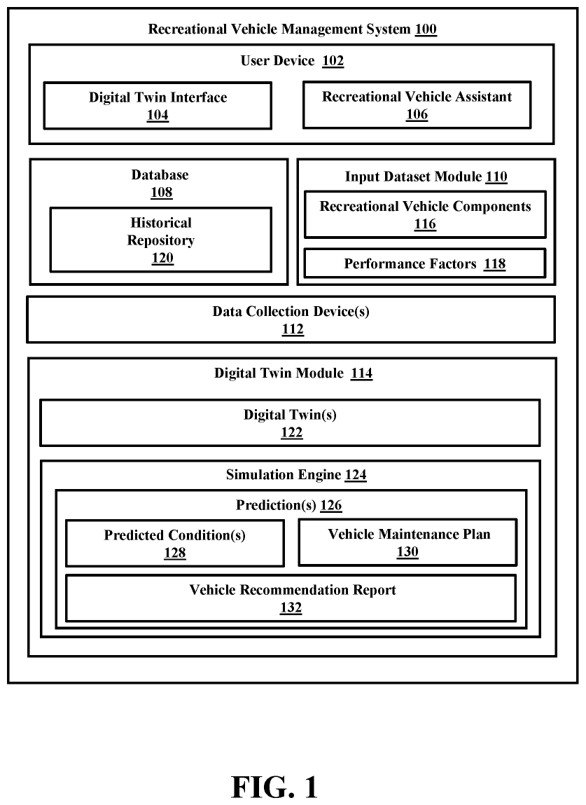

Turning now to the figures, FIG. 1 depicts a recreational vehicle management system 100 for managing and/or maintaining a vehicle exposed to one or more conditions, in accordance with embodiments of the present disclosure. In embodiments, recreational vehicle management system 100 leverages the use of digital twin technology to effectively manage a vehicle, or recreational vehicle subjected to one or more conditions. FIG. 1 provides an illustration of only one embodiment and does not imply any limitations with regard to the environments in which different embodiments may be implemented. Many modifications to the depicted environment may be made by those skilled in the art without departing from the scope of the invention as recited by the claims.

Recreational vehicle management system 100 may be a standalone computing system, a server, and/or a virtualized system running on one or more servers within a cloud networking environment capable leveraging digital twin technology to manage and/or maintain a recreational vehicle. Recreational vehicle management system 100 may be configured to manage and/or maintain any type of motor vehicle or recreational vehicle, that may be used to transport one or more people or objects through one or more environments. While various embodiments contemplated herein often refer to embodiments including particular vehicles, such as campers, amphibious vehicles, houseboats, and motorhomes, fifth wheels, toy haulers, and other vehicle configurations may also be included. Vehicle types that may be substituted, included, and/or considered a recreational vehicle may include, but are not limited to, industrial vehicles (e.g., tractor trailers), commercial vehicles (e.g., special purpose work vans), as well as vehicles having a plurality of systems (e.g., modular systems). For example, a recreational vehicle may include, but is not limited to having one or more the following systems (e.g., comprising one or more vehicle components): waterpipe system, hydraulic system, cooling system, power systems, braking system, heating system, solar panel system, electrical system, appliances, pest hygiene systems, various accessory systems (e.g., attached canopies, awnings, lighting, wipers, window sealants, and pest netting), and/or recreational vehicle related appliances (e.g., cooking stove, microwave, entertainment systems, etc.).

In embodiments, a system that enables proactive maintenance, such as recreational vehicle management system 100, may ensure and reduce not only the occurrence of recreational vehicle breakdown, but ensure proactive or necessary maintenance is performed at optimal times. Using embodiments contemplated herein, recreational vehicle management system 100 can simulate and monitor the operational capabilities of the recreational vehicle using artificial intelligence (AI) enabled digital twin technology. By generating and simulating a recreational vehicle digital twin proactive maintenance can be scheduled prior to vehicle breakdown during times the vehicle is not intended to be used. In some embodiments, the recreational vehicle managed by recreational vehicle management system 100 can be a physical recreational vehicle that is already built or can also be a proposed design (e.g., a blueprint of the recreational vehicle). In such embodiments where a proposed design is utilized, recreational vehicle management system 100 can be configured to predict how usage of the proposed recreational vehicle design and proposed vehicle components perform over time and/or in different environments (e.g., heavy rain or sandy terrain).

In embodiments, recreational vehicle management system 100 may include user device 102, database 108, input dataset module 110, data collection device(s) 112, and digital twin module 114. Recreational vehicle management system 100 can be implemented as an application running on a user's computing device (e.g., user device 102), as a service offered via the cloud, as a web browser plugin, as a smartphone application, or as a codependent application attached to a secondary application (e.g., as an “overlay” or a companion application to a partner application, such as text messaging application).

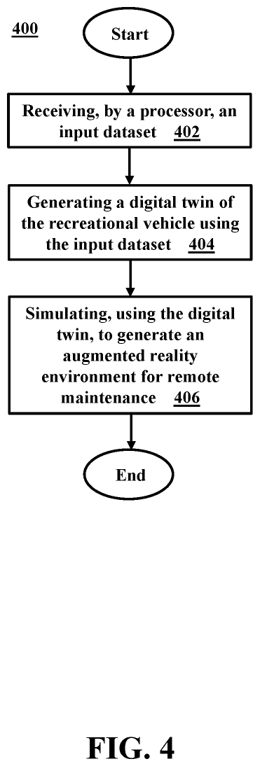

The term “module” may refer to a hardware module, software module, or a module may be a combination of hardware and software resources. Embodiments of hardware-based modules may include self-contained components such as chipsets, specialized circuitry, one or more memory devices and/or persistent storage (see FIG. 4). A software-based module may be part of a program (e.g., programs 628, FIG. 4), program code or linked to program code containing specifically programmed instructions loaded into a memory device or persistent storage device of one a data processing systems operating as part of the computing environment 100. For example, data associated with digital twin module 114, depicted in FIG. 1, can be loaded into memory or a database, such as database 108.

In embodiments, user device 102 can be a component of recreational vehicle management system 100. In these embodiments, user device 102 may include all of the components, or fewer than all the components necessary to implement recreational vehicle management system 100. For example, input dataset module 110, can be configured on user device 102 while digital twin module 114 may be configured on a separate device. In embodiments, user device 102 may be a laptop computer, tablet computer, smartphone, smartwatch, or any other computing device that allows for a user to interact with and execute the methods and/or techniques described herein. In various embodiments, user device 102 may provide a user with information and/or one or more findings identified by recreational vehicle management system 100 via digital twin interface 104 (e.g., maintenance information). In some embodiments, digital twin interface 104 can provide an interface between user device 104 and recreational vehicle management system 100.

Digital twin interface 104 can be a graphical user interface (GUI), a web user interface (WUI) or any other suitable interface for a user to interact with and execute the methods and/or techniques described herein. As described herein, this information can be provided to a user in any format. For example, information may be relayed to a user via user device 102 via video, audio, images, text (e.g., charts, weather condition readings, or vehicle parameter readings), or any combination thereof. User device 102 can represent any programmable electronic devices or combination of programmable electronic devices, capable of executing machine readable program instructions and as well as capable of communicating with other computing devices (not shown) within recreational vehicle management system 100 via network 102. While in some embodiments, user device 102 may be configured on a mobile device, in other embodiments, user device 102 may be configured within the recreational vehicle. In some embodiments, user device 102 may be comprise a plurality of devices, both stationary (e.g., comprised within the recreational vehicle) and portable (e.g., mobile phone), that may enable a user to access recreational vehicle management system 100 and/or information associated with recreational vehicle management system 100 (e.g., proactive maintenance plan).

In some embodiments, user device 102 may include a recreational vehicle assistant 106. While in some embodiments, recreational vehicle assistant 106 may be included in the digital twin interface 104, in other embodiments, recreational vehicle assistant 106 may be configured independently of digital twin interface 104. Recreational vehicle assistant 106 may include a virtual avatar and voice that may be configured to interact with users of the recreational vehicle. For example, recreational vehicle management system 100 configure recreational vehicle assistant 106 using artificial intelligence capabilities (e.g., via digital twin module 114) to build a corpus of intents, entities, contexts, and appropriate usage gestures that may be used to train recreational vehicle assistant 106. In embodiments, recreational vehicle assistant 106 may interact with a user and provide various forms of helpful information to a user. In one example embodiment, recreational vehicle assistant 106 may be configured to provide the location of possible parks (e.g., motorhome parks) based on information generated (e.g., resupply information, such as water, power, etc.) from recreational vehicle management system 100 (e.g., digital twin module 114). In this example embodiment, recreational vehicle assistant 106 may receive information (e.g., from data collection devices 112) associated with the recreational vehicle indicating the recreational vehicle is low on power. In this example, recreational vehicle assistant 106 and may provide the user with a selection of parks that have power available while omitting those parks that do not have that resource. In some embodiments, recreational vehicle assistant 106 may be configured to provide a user with applicable tools and suggested halt stations relevant to the type of recreational vehicle.

In embodiments, database 108 may be configured to store a wide variety of information and different data types, as contemplated herein. While in some embodiments database 108 is a single database configured to maintain one or more libraries of information and historical repository 120, in other embodiments, historical repository 120 is separately situated from database 108. In embodiments, database 108 can include one or more libraries of data including, but not limited to, vehicle user manuals and/or guides, uploaded or digitized maintenance records (e.g., information associated with a replaced or repaired vehicle component), vehicle standards, data associated with vehicle conditions, data associated with the recreational vehicle's vehicle components, or any other data necessary to manage a recreational vehicle, as contemplated herein. Such data can be accessed from database 108 by recreational vehicle management system 100, or individually by input dataset module 110 and/or digital twin module 114, as needed. Database 108 may be configured to store data in various formats including, but not limited to audio and video recordings, readings, images, repositories of system data (e.g., user preferences), and/or any other data format type that can be capable of storing relevant recreational vehicle data used by recreational vehicle management system 100. In embodiments, database 108 can reside on a single server, on multiple servers within a cloud computing environment, on user system 104 and/or on the same physical system or virtualized system as recreational vehicle management system 100.

In embodiments, recreational vehicle management system 100 may include historical repository 120. In some embodiments, historical repository 120 can be independently situated from other components in recreational vehicle management system 100, while in other embodiments, historical repository 120 can be a component of, database 108, digital twin module 114, input dataset module 110, or any combination thereof. In embodiments, recreational vehicle management system 100 can configure historical repository 120 to receive and store information or data analyzed or determined from a particular recreational vehicle managed by recreational vehicle management system 100.

In embodiments, recreational vehicle management system 100 may be configured to receive one or more input datasets via input dataset module 110. Input dataset module 110 can provide recreational vehicle management system 100 with information and data (e.g., input dataset) about one or more particular recreational vehicles to be managed by the system. In embodiments, input dataset module 110 may be configured to receive one or more vehicle system documents or digital files. In these embodiments, input dataset module 110 can be configured to convert the documents or digital files into one or more input datasets having plurality of recreational vehicle components 116 and/or one or more performance factors 118. Input datasets, derived from documents or digital files, can be used to infer how a particular vehicle or structure would be constructed (e.g., using recreational vehicle components 116) and perform (e.g., performance factors 118) if the design was implemented in real-life.

In embodiments, plurality of recreational vehicle components 116 may include any material or component used to construct one or more systems of the recreational vehicle. These components/materials may include, but are not limited to, individual component parts associated with the recreational vehicle (e.g., engine, wheels, vehicle frame, piping, etc.), ventilation system components, electrical system components, water system components, heating and/or air conditioning components, and any other utility that might be incorporated into a vehicle. In some embodiments, recreational vehicle components 116 may further include how each component is configured and/or data information associated particular vehicle components. For example, plurality recreational vehicle components 116 can include information and data not only associated with a particular vehicle design (e.g., vehicle having a particular electrical system), but also data regarding various brands of vehicle components, possible material of the particular vehicle component, and one or more performance parameters.

In embodiments, performance parameters can include any relevant information associated with the specific recreational vehicle components 116. For example, a waterpipe system of a vehicle might have a particular brand or type of pipe. In this example, a performance parameter of the particular pipe could include information such as, crack growth resistance, environmental stress crack resistance, tensile and compressive strength, minimum and maximum pressure limits, pipe diameter, and pipe wall thickness. In some embodiments, input dataset can provide partial information that can be linked to additional data or information stored in database 108. For example, input dataset module 110 can identify a particular material (e.g., type of metal) used as a recreational vehicle component 116 within the recreational vehicle, from the input dataset, and retrieve relevant data or performance parameters (e.g., amount of pressure a particular pipe can withstand) associated with that particular brand of particular pipe stored in database 108.

In embodiments, performance factors 118 can include one or more factors that influence how the recreational vehicle functions and performs during different conditions (e.g., towing weight, load balancing capabilities). More particularly, performance factors 118 can provide information and data regarding how conditions may influence or impact one or more of the plurality of recreational vehicle components 116 and can include any factor that affects the operation and use of the recreational vehicle. Performance factors 118 may include such factors including, but not limited to, the type of windows used (e.g., noise suppression, breakability, water resistance, etc.) in the vehicle, durability or structure of the vehicle walls (e.g., spacing of vehicle frame, thickness of walls), how the recreational vehicle may perform under different environmental conditions (e.g., both those environments the recreational vehicle is designed for and those the recreational vehicle was not designed for), how the recreational vehicle performs while carrying and/or pulling various objects, how weight and weight distribution affects the operation of the recreational vehicle (e.g., weight management and load balancing), etc. While in some embodiments performance factors 118 are configured from the technical specifications of the particular component (e.g., technical specification states a particular pipe type can only maintain a pressure below a specific level), in other embodiments, performance factors 118 may also include actual data observed by recreational vehicle management system 100 (e.g., data collection devices 112).

In embodiments where one or more of the plurality of recreational vehicle components 116 may not be definitively identified from the design documents or digital files (e.g., input dataset) and/or performance factors 118 are not provided in either the design documents or database 108, recreational vehicle management system 100 may be configured to determine what the missing recreational vehicle components 116 or performance factors 118 are. In some embodiments, recreational vehicle management system 100 may identify that one or more of the plurality of recreational vehicle components 116 or one or more performance factors 118 are missing and send a message to the user, via user device 102, indicating that the information is not available.

In these embodiments, recreational vehicle management system 100 can, using various methods contemplated herein: i) request a user to input information or data associated with the missing construction component or missing performance factor; ii) make a recommendation on what the one or more missing vehicle components or performance factor should be (e.g., use machine learning to extrapolate a similar waterpipe component or performance factor, based, at least in part, on the information and data from input dataset module 110 and database 108 and/or historical repository 120); iii) automatically select the most likely construction component or performance factor that would fulfill the missing recreational vehicle components 116 or performance factor 118 role; or iv) any combination thereof.

In embodiments, input dataset module 110 may be configured to receive information and data (e.g., plurality of recreational vehicle components 116 and/or performance factors 118) regarding a particular recreational vehicle and how the recreational vehicle performs via one or more data collection devices 112. In some embodiments, data collection device(s) 112 may be connected or coupled to, or in close proximity to, one or more of the plurality of recreational vehicle components 116 that make up the vehicle or structure. The one or more data collection devices 112 may be coupled to any internal or external construction component, such as doors, windows, walls, at various points in the electrical system, at various points in the recreational vehicle or any other component that could be impacted during different conditions. Data collection device(s) 112 may include, but are not limited to, one or more sensors, IoT (Internet of Things) devices, and recording systems configured to capture performance factors 118 associated with a particular recreational vehicle. In these embodiments, recreational vehicle management system 100 may configure one or more data collection devices 112 to identify one or more of the plurality of recreational vehicle components 116 and/or performance factors 118 of the recreational vehicle to provide a real-time data feed.

In embodiments, recreational vehicle management system 100 can configure data collection devices 112 to provide, not only a real-time feed of the status of the recreational vehicle, but can also provide data and information (e.g., performance factors 118) regarding conditions surrounding one or more of the plurality of recreational vehicle components 116 of the recreational vehicle (e.g., temperature of a particular recreational vehicle components 116). As contemplated herein, performance factors 118 may include any element/factor that is capable of affecting how the recreational vehicle functions, particularly as it relates to withstanding various conditions (e.g., time, different environments, etc.). Input dataset module 110 can be configured to receive information and data collected from data collection device(s) and identify one or more performance factors 118 that affect a particular vehicle component and/or the complete recreational vehicle in real-time.

These performance factors 118 may include, but are not limited to: i) actual condition of recreational vehicle components 116 (e.g., possible leaking of a pipe, weakening of vehicle component, damage to the vehicle, etc.); ii) data readings of one or more recreational vehicle components 116 under different conditions (e.g., how the structure may be affected by terrain changes); iii) real-time data associated with operational utilities (e.g., water systems, electrical system, etc.), and where the utilities are being utilized within the recreational vehicle.

In some embodiments, data collection device(s) 112 may provide input dataset module 110, with sufficient data (e.g., one or more input datasets) to define the plurality of recreational vehicle components 116 and performance factors 118 associated with the recreational vehicle of interest. In other embodiments, input dataset module 110 can configure the data and information collected by one or more data collection device(s) 112 and combine it with a document or digital file of the recreational vehicle (e.g., blueprint or design model of recreational vehicle) to define the plurality of recreational vehicle components 116 and performance factors 118 associated with the recreational vehicle of interest.

In embodiments, recreational vehicle management system 100 may configure recreational vehicle assistant 106 to receive relevant information from one or more systems. In these embodiments, recreational vehicle assistant 106 to notify a user of the recreational vehicle of an incorrect, inefficient, and or incomplete action associated with the recreational vehicle. For example, prior to particular moving the vehicle and traveling from one location to another, data collection devices 112 associated with various recreational vehicle components 116 may provide recreational vehicle assistant 106 with information such as whether cabinets in the vehicle are locked, whether the canopy is properly/completely collapsed, whether the vehicle is unplugged from the power supply, emptying of wastewater from waterpipe system, ensuring a trailer is properly attached to the recreational vehicle, etc. Recreational vehicle assistant 106 may receive this information and relay relevant information to the user prior to initiating travel. Such embodiments ensure fewer mishaps or accidents that may result in unpredicted recreational vehicle maintenance. In some embodiments, recreational vehicle assistant 106 may notify the user of various qualities associated with the recreational vehicle including, but not limited to, leakages of cooled air from the air conditioner, internal air quality of the recreational vehicle (e.g., motorhomes), and if there is an accumulation of carbon monoxide within the recreational vehicle.

In embodiments, digital twin module 114 may be configured to receive recreational vehicle components 116 and performance factors 118 from input dataset module 110 associated with the recreational vehicle. In embodiments, digital twin module 114 can generate digital twin 122 and simulate one or more features of a particular recreational vehicle that may result (e.g., be impacted) from one or more conditions to provide a user with prediction 126. Prediction 126 can allow the user to determine how one or more features of the particular recreational vehicle would be impacted if the recreational vehicle were subjected to the one or more conditions in real life.

In some embodiments, recreational vehicle management system 100 can be configured to receive information and data regarding the structure design/configuration of the vehicle during construction. In these embodiments, IoT sensors, imaging technology, and various scanning method (e.g., via data collection devices 112) may be used to determine how the vehicle was constructed. In some embodiments where construction of a recreational vehicle is already completed, ultrasound and other technology may be implemented to identify how the vehicle was constructed. Such devices and methods can be configured to identify different recreational vehicle components 116 and performance factors 118.

While in some embodiments, recreational vehicle management system 100 may configure one or more data collection devices 112 to provide a “snapshot” depicting the state of the recreational vehicle at a particular instance, in other embodiments, recreational vehicle management system 100 can configure one or more data collection devices 112 to provide a more comprehensive surveillance of the recreational vehicle. In embodiments, recreational vehicle management system 100 can configure one or more data collection devices 112 to: i) constantly survey the recreational vehicle and relay the information and data to recreational vehicle management system 100; ii) intermittently survey the recreational vehicle (e.g., survey at particular timed intervals); iii) data collection device(s) 112 can be configured to relay information only when there is information indicating a significant change in one or more recreational vehicle components 116 or performance factors 118 of the recreational vehicle; or any combination thereof. recreational vehicle management system 100 can configure one or more data collection devices 112 to collect and store this observed or historical data in historical repository 120. In embodiments, the historical data stored in historical repository 120 can be used by input dataset module 110 to define the recreational vehicle's configuration, and/or by digital twin module 114 to generate digital twin 122 and enable recreational vehicle management system 100 to simulate digital twin 122 and generate prediction 126 using simulation engine 124.

In embodiments, recreational vehicle management system 100 can use the historical data stored in historical repository 120, to produce predicted conditions of one or more features of the recreational vehicle (e.g., the one or more features that may be impacted by one or more conditions). In embodiments, recreational vehicle management system 100 may configure the historical data stored in historical repository 120 to identify one or more observed performance factors in the recreational vehicle that can indicate a potential change in one or more of the plurality of recreational vehicle components 116 and/or other performance factors 118. In one example embodiment, one or more data collection devices 112 over a period of time can observe changes to the recreational vehicle as a result of time and/or conditions and detect how the occurrence of the particular conditions can then affect other performance factors 118. In embodiments, recreational vehicle management system 100 can discern, using statistical modeling, deep learning models, machine learning models, or a combination thereof, if and how a particular performance factor 118 will influence one or more recreational vehicle components 116 and/or other related performance factors 118 of the recreational vehicle (e.g., how damage to one side of the vehicle results in other additional recreational vehicle components 116 being impacted).

In embodiments, recreational vehicle management system 100 may use the aforementioned techniques to identify historical patterns from the historical data collected by one or more data collection devices 112 and stored in historical repository 120. An historical pattern can include, but is not limited to, identifying one or more particular performance factors 118 observed from one or more data collection devices 112 that causes a particular condition to one or more recreational vehicle components 116 in the recreational vehicle, determining the effect of a particular performance factor 118 on one or more recreational vehicle components 116 over a particular period of time, determining the time period associated with the worsening (or improving) condition of the recreational vehicle components 116, and determining how an observed/detected performance factor impacts the use and operation of the recreational vehicle. One example of a historical pattern could be how damage to one vehicle component of a particular system (e.g., rusting of a tank in the waterpipe system) of the recreational vehicle can cause the integrity and safety of the entire vehicle to be diminished. Recreational vehicle management system 100 can use the various techniques contemplated herein (e.g., machine learning and AI enabled digital twin technology) and information stored in historical repository 120 to identify an historical pattern associated with the repercussions of different conditions.

In embodiments, recreational vehicle management system 100 can be configured to manage and observe more than one particular vehicle. In such embodiments, historical repository 120 may be configured to store information and data associated with each recreational vehicle. While in some embodiments, historical patterns for a particular recreational vehicle are determined from the historical data observed/collected only from that particular recreational vehicle, in other embodiments, recreational vehicle management system 100 can configure historical repository 120 to identify historical patterns associated with historical data observed/collected from all recreational vehicle managed by recreational vehicle management system 100.

In embodiments, recreational vehicle management system 100 may be configured to generate a digital twin 122 of a particular recreational vehicle using digital twin module 114. Digital twin module 114 may further include simulation engine 124. In embodiments, digital twin module 114 may be configured to receive one or more input datasets form input dataset module 110 associated with the particular recreational vehicle of interest to generate one or more digital twins 122. Digital twin 122 may be generated using various artificial intelligence techniques to create a digital representation that mimics the structure and performance of a particular recreational vehicle of interest. Using digital twin 122 of a particular recreational vehicle, one or more systems or system modules of the recreational vehicle may be simulated by simulation engine 124. In embodiments, some or all of generated digital twins 122 and/or information generated by simulation engine 124 (e.g., prediction 126) may be stored in database 108 (e.g., historical repository 120).

In embodiments, recreational vehicle management system 100 can provide digital twin services via digital twin module 114 to users connecting and assessing digital twin module 114 via user device 102. In these embodiments, the digital twin services and/or access may be provided to owners, purchasers, licensees, manufacturers, sellers, licensors, and other authorized individuals (collectively referred to herein as “users”) of the digital twins being accessed. Embodiments of recreational vehicle management system 100 may execute program code of digital twin module 114, including, but not limited to, i) retrieving and creating digital twin 122 models; ii) aggregating, organizing, and storing data generated by data collection device(s) 112 (e.g., sensor devices, IoT devices, and or recording systems) associated with the recreational vehicle of interest; and iii) monitoring changes in the operating conditions of the recreational vehicle, including operation and changes associated with of plurality of recreational vehicle components 116 (e.g., sealant, motors, pumps, vents, filters etc.) and performance factors 118 of the recreational vehicle of interest as reflected by the digital twin. In embodiments where a recreational vehicle component 116 is replaced with a new or different recreational vehicle components 116, digital twin module 114 reconfigures and/or updates digital twin 122 of the recreational vehicle to reflect the change or alteration to recreational vehicle components 116.

In embodiments, recreational vehicle management system 100 may configure digital twin module 114 to simulate digital twin 122 using simulation engine 124. In these embodiments, simulation engine 124 may simulate the impact of one or more conditions on one or more features (e.g., recreational vehicle components 116 and performance factors 118) recreational vehicle (e.g., digital twin of the recreational vehicle) to generate a prediction (e.g., prediction 126). In these embodiments, one or more features can refer to any element of the recreational vehicle that is of interest to a user and/or that may be impacted by one or more conditions. Recreational vehicle management system 100 can determine how one or more features (e.g., particular recreational vehicle components 116 and/or particular performance factors 118) of a recreational vehicle are impacted when a particular stimuli or one or more changes (e.g., one or more conditions) are applied to the recreational vehicle by applying a simulation (e.g., via simulation engine 124) of the stimuli to the digital twin 122 of the recreational vehicle. Examples of simulated impacts include, but are not limited to, how one or more features (e.g., recreational vehicle components 116 and performance factors 118) may be impacted and/or how the one or more features perform at particular temperatures, how the recreational vehicle performs over a particular time duration, if some portion the water contained within the recreational vehicle's waterpipe system is contaminated, and how the recreational vehicle operates in different environments (e.g., dessert, snow/ice, land, water, and transition between environments). In embodiments, generating one or more digital twins 122 and generating one or more simulations of the digital twin 122 using simulation engine 124, allows recreational vehicle management system 100 to provide the user with predictive information that may reduce or mitigate possible recreational vehicle problems prior to occurrence, reduce downtime resulting from recreational vehicle breakdown, provide the user with one or more digital twin simulations that allows them to plan a more productive trip (e.g., avoid conditions the recreational vehicle is not suited for), and to improve upon the design of one or more recreational vehicles.

In embodiments, simulation engine 124 may be configured to receive historical data and historical patterns stored in historical repository 120 to generate prediction(s) 126 having one or more predicted conditions 128, vehicle maintenance plans 130, vehicle efficiency report 132 and/or any other predictable component a user may find useful. Prediction 126 can send reports associated with simulation results to users that can include proposed actions to the users.

In some embodiments, prediction 126 via simulation engine 124 may provide one or more vehicle maintenance plan(s) 130 that may be associated with and/or include one or more predicted conditions 128. In embodiments, predictions 126 may include, but are not limited to simulation results associated with detecting anomalies, predicting damage to one or more recreational vehicle components 116 (e.g., by simulating various effects, such as the changes to a recreational vehicle's one or more recreational vehicle components 116 resulting from exposure to environmental conditions changing over time), identifying why one or more faults/defects of the recreational vehicle (e.g., defects in recreational vehicle components 116) may be occurring, determining if the predicted damage requires maintenance (e.g., corrective maintenance and/or preventative maintenance) to mitigate the damage, and determining how long the system may be operated before one or more subcomponents (e.g., recreational vehicle components 116) fails to perform as intended and/or the entire system fails.

In embodiments, prediction 126 may further provide a user with a description of parameters considered by simulation engine 124 while simulating the digital twin 122 of the recreational vehicle to produce prediction 126. A user may review each of the predictions associated with the recreational vehicle of interest comprising, one or more predicted conditions 128 and vehicle maintenance plans 130. In these embodiments, the user may select one or more actions based off of predictions 126, such as scheduling maintenance for the vehicle. Any predictions 126 generated by digital twin module 114, as contemplated herein, may be included in vehicle maintenance plan 130.

In embodiments, prediction 126 can further include one or more accuracy indicators, determined by digital twin module 114, indicating the accuracy of prediction 126 (e.g., using calculation of percent error). In some embodiments, while a high accuracy indicator can imply that some or all of the data used by digital twin module 114 to generate the one or more digital twins 122 and simulate the one or more prediction 126 is known or well understood, a low accuracy indicator can imply that some portion of relevant data associated with the recreational vehicle of interest is omitted. In these embodiments relevant data can include, but is not limited to, any data associated with input dataset module 110, database 108, historical repository 120, data collection device(s) 112, or digital twin module 114, that is used to define the recreational vehicle of interest.

Relevant data may be omitted by digital twin module 114 for a variety of reasons including, but not limited to, determining that the relevant data is missing or unavailable within recreational vehicle management system 100 and/or determining the relevant data collected (e.g., from a broken data collection device 112) is, more likely than not, inaccurate. For example, one or more data collection devices 112 could be faulty (e.g., damaged by the environment) and provide recreational vehicle management system 100 with incorrect information. In these embodiments, recreational vehicle management system 100 may independently determine or receive an indication (e.g., via message from a data collection device 112 having a built-in self-test) that one or more of data collection devices 112 is defective/broken and the data, if any data is received, should be disregarded or omitted.

In other embodiments, recreational vehicle management system 100 can receive a data reading from one or more data collection devices 112 and determine that the data is inaccurate by comparing the data reading to the other data readings received by neighboring data collection devices 112 or by comparing the data reading to data readings collected and stored in historical repository 120. In these embodiments, recreational vehicle management system 100 can use techniques contemplated herein (e.g., AI and machine learning techniques) to identify whether the data reading is likely inaccurate and should be omitted or if the data reading is indicative of a particular condition of one or more of the plurality of recreational vehicle components 116 and/or a change in one or more performance factors 118.

In embodiments, where relevant data is omitted from digital twin module 114 with the recreational vehicle of interest, recreational vehicle management system 100 may utilize information from various libraries housed within database 108 (e.g., recreational vehicle user manual or guides, digitized maintenance records, etc.), historical repository 120, and/or one or more data collection device(s) 112 (e.g., a neighboring data collection device 112 proximate to the faulty data collection device 112) to fill in the missing data. In embodiments, where some portion of the data necessary to generate one or more digital twins 122 and/or to perform the simulation via simulation engine 124 is omitted, recreational vehicle management system 100 may configure digital twin module 114 to make intelligent extrapolations based on the data available to make assumptions on the data missing. Depending on the data used to make the intelligent extrapolations, digital twin module 114 can assign a reliability score to the data used.

For example, data associated with a particular recreational vehicle stored historical repository 120 could have a high reliability score when used to fill in omitted data/information needed to generate/simulate digital twin 122, while data from database 108, that could generically apply to many different vehicles, could have a lower reliability score. In embodiments, the various reliability scores used by digital twin module 114 can be accumulated to generate the one or more accuracy indicators. As discussed herein, the accuracy indicators can provide a confidence level to a user regarding how accurate the prediction 126 is and if the one or more predicted conditions 128 provided are more likely than not to occur in the actual recreational vehicle. In embodiments where prediction 126 is based, at least in part, on historical repository 120 (e.g., and the data collected from the recreational vehicle via data collection devices 112), as more data is collected over time digital twin module 114 and more particularly, simulation engine 124 may generate more accurate predictions 126 (e.g., predicted conditions 128, vehicle maintenance plan 130, and vehicle efficiency report 132) associated with the particular digital twin 122 of the recreational vehicle.

In embodiments, the prediction 126 generated by digital twin module 114 and configured by recreational vehicle management system 100 can recommend a vehicle reconfiguration or new/updated vehicle design to mitigate the one or more predicted conditions associated with the usage and operation of the recreational vehicle. In these embodiments, digital twin module 114, input dataset module 110, data collection devices 112, and historical repository 120 may be configured by simulation engine 124 to simulate the generated digital twin 122 to produce one or more prediction 126. In embodiments, predictions 126 may include, but is not limited to, one or more predicted conditions 128 of the recreational vehicle and vehicle maintenance plan 130.

In embodiments, prediction 126 may identify one or more predicted conditions 128 of the recreational vehicle, one or more of the plurality of recreational vehicle components 116, one or more performance factors that may affect or impact the recreational vehicle (e.g., predicted vehicle condition 128) under one or more conditions (e.g., how the recreational vehicle operates under high temperatures). In embodiments, simulation engine 124 may generate a vehicle maintenance plan 130. Vehicle maintenance plan 130 may include, but is not limited to, information associated with how the recreational vehicle may be altered to prevent or mitigate the one or more predicted conditions from occurring, how the vehicle design/configuration may be improved upon to reduce use related damage and potential vehicle failures. For example, an amphibious recreational vehicle design may utilize a particular sealant commonly used to construct boats, but due to the dual nature of the amphibious recreational vehicle the sealant dries and cracks when the vehicle is on land resulting in water leakage when the amphibious recreational vehicle returns to the water. In this example, simulation engine 124 could perform a simulation on the amphibious recreational vehicle's digital twin to generate the impact of the amphibious vehicle moving from water to land. In this example, simulation engine 124 could generate predictions 126 having one or more predicted conditions 128 including how the sealant operates when exposed to different environments (e.g., forms leaks). Continuing this example, simulation engine 124 could produce vehicle maintenance plan 130 that includes information associated with what sealant should replace the faulty sealant and/or how the sealant may be replaced (e.g., remote maintenance) in an amphibious recreational vehicle currently in use. In embodiments, prediction(s) 126 (e.g., predicted conditions 128 and/or vehicle maintenance plan 130) may be sent to the user (e.g., vehicle owner) before the recreational vehicle is exposed to one or more conditions simulated. In such embodiments, the vehicle maintenance plan 130 may include the expected damages to the recreational (e.g., providing a list of expected damaged recreational vehicle components 116), the specific mitigation factors that must be taken to reduce or prevent the expected damages, what damages might occur despite performing additional vehicle maintenance and following the specified mitigation factors, instructions regarding how current damage may be repaired, as well as suggestions on where a user may have the proactive maintenance/mitigating factors addressed (e.g., the closest recreational vehicle mechanic).

In some embodiments, simulation engine 124 may also include one or more predictions 126 having one or more recommendations associated with the recreational vehicle that may be included in a vehicle efficiency report 132 (e.g., based, at least in part, on predicted conditions 128). In such embodiments, vehicle efficiency report 132 may include various recommendation to a user associated with the operation of the recreational vehicle, such as how the recreational vehicle may be operated efficiently while also performing as the user intends. In one example embodiment, a motorhome (e.g., a recreational vehicle) may have a cooling system associated with the vehicle portion of the motorhome and a secondary air-conditioning cooling system associated with the living quarters of the motorhome. In traditional motorhomes, it is likely that both systems may be running simultaneously. Using embodiments contemplated herein, simulation engine 124 may simulate the impact of running both cooling systems at the same time and determine (e.g., predict) if the particular use leads to unwanted and/or inefficient usage of gas and/or electricity.

In these embodiments, simulation engine 124 may be configured to recommend to the user how the separate cooling systems may be configured to run efficiently. While in some embodiments, a recommendation may include identifying particular recreational vehicle settings that allow the vehicle to run optimally, in other embodiments, a recommendation may include recommending a particular recreational vehicle components 116 should be replaced (e.g., replacement of an air filter that is not yet impaired to the level requiring replacement, but is impaired/clogged to the level it reduces the efficiency of airflow) or if there are other updated components that may be purchased to allow the recreational vehicle to run efficiently (e.g., by updating the living quarter air-conditioning system you can reduce the usage associated with the vehicle based cooling system). While in some embodiments, vehicle efficiency report 132 may be an independent report separate from vehicle maintenance plan 130, in other embodiments, vehicle efficiency report 132 may be incorporated in vehicle maintenance plan 130. In embodiments, recreational vehicle management system 100 may configure recreational vehicle assistant 106 to provide a user with prediction(s) 126 generated by simulation engine 124.

As contemplated herein, recreational vehicle maintenance management system 100 may be configured to provide a cornucopia of information that may not only reduce the likelihood of failure or complete breakdown of the recreational vehicle, but also minimize maintenance expenses by addressing potential issues early, downtime related to vehicle repair, and ensuring the safety of users utilizing the recreational vehicle. In some embodiments, recreational vehicle maintenance management system 100 may be used to perform weight management and/or load balancing of the recreational vehicle. Such embodiments may be use on various types of recreational vehicles, such as towing campers or trailer type motorhomes.

In some embodiments, digital twin module 114 may analyze various performance factors 118 while simulating and predicting (e.g., computing) various weight parameters. For example, digital twin module 114 may be configured to compute the gross vehicle weight rating (GVWR). GVWR is the maximum operating weight/mass of a vehicle as specified by the manufacturer. Often, the GVWR includes the vehicle's chassis, body, engine, engine fluids, fuel, accessories, driver, and passenger. In another example, digital twin module 114 may be configured to compute the gross combined weight rating (GCWR). GCWR is the total allowable combined mass of a road vehicle. Often, the GCWR computation includes the passengers and cargo stored in a tow vehicle (e.g., camper, trailer, etc.) and the weight/mass of the trailer and cargo in the trailer. In another example, digital twin 114 may be configured to compute the curb weight. Curb weight is the total mass of a recreational vehicle with standard equipment and the operating consumables required to operate the vehicle (e.g., oil, coolant, fuel, etc.).

In embodiments, digital twin module 114 of recreational vehicle management system 100 may consider various performance factors 118 while simulating and predicting how the recreational vehicle may perform while managing different load amounts and distributions. In one example embodiment, digital twin module 114 may use performance factors such as the construction of the recreational vehicle (e.g., motorhome), various dynamic weighing parameters (e.g., vehicle weight, trailer weight, towing weight, kingpin weight, tongue weight, rub weight, dry weight). In this example embodiment, digital twin module 114 could use this information and other information, as contemplated herein, to generate one or more predictions 126. In this example, predictions 126 could include, but are not limited to, a user receiving a recommendation on how particular objects may be optimally places to ensure the weight limits are not exceeded while the load is properly balanced, potential for the recreational vehicle to sway, generate personalized ant-sway driving recommendations (e.g., speed limits, turn radius, breaking torque, etc.) based, at least in part, on proposed road conditions, driving pattern, and/or notifying a user (e.g., via recreational vehicle assistant 106) if the weight limit has been exceeded or if the load has shifted (e.g., during operation of the vehicle) to create an imbalance.

In some embodiments, digital twin module 114 may be configured to provide smart power management. Smart power management may be based on the power supply source (e.g., generator, shore power, etc.), power drawn from various recreational vehicle systems and appliances. By providing the recreational vehicle with smart power management, digital twin 114 may enable and/or disable power to specific sub modules of the recreational vehicle to ensure the vehicle is utilizing power efficiently and effectively, while also minimizing unwanted circuit breaker or fuse failures.

In some embodiments, digital twin module 114 may be configured to provide fault modeling localization and/or behavior verification. In these embodiments, digital twin 114 may use knowledge graph networks when one or more of the recreational vehicle components 116 is identified as faulty. In these embodiments, digital twin module 114 may be configured to generate alternate integration paths and modeling (e.g., either automated or semi-automated) to fix the critical issue by balancing the overall module integrations.

In some example embodiments, as contemplated herein, digital twin module 114 may generate a digital twin of one or more systems of the recreational vehicle. This information (e.g., predictions 126) may be relayed to the user via recreational vehicle assistant 106. For example, in some embodiments, digital twin module 114 may be configured to generate and simulate a digital twin associated with a portion of, or the complete system associated with the hydraulic system of the recreational vehicle. For example, digital twin module 114 may configure one or more hydraulic system subcomponents that may include, but are not limited to, the side slide outs of recreational vehicle, parking hydraulics, and/or the drop-down bed (e.g., in a camper or motorhome). In these embodiments, digital twin module 114 may use simulation engine 124 to simulate and generate one or more predictions 126 (e.g., predicted conditions 128, vehicle maintenance plan 130, and/or vehicle recommendation report 132) that may provide a user with information regarding the hydraulic system and/or one of its subcomponents regarding whether the system or subcomponent may need to be reset or tuned in order for the system or subcomponent to achieve proper balance and/or complete extraction (e.g., parking hydraulics).

In some embodiments, digital twin module 114 may be configured to receive real-time and/or historical weather information from input dataset module 110 (e.g., via weather satellites and/or weather databases). In these embodiments, digital twin module 114 may be configured to generate one or more predictions 126 regarding how the recreational vehicle may operate in different weather and how the weather may impact one or more recreational vehicle components 116. Using this information, digital twin module 114 may be configured to produce one or more alerts (e.g., via recreational vehicle assistant 106) associated with seasonal changes (e.g., fall season to the snowy winter season) to ensure the recreational vehicle is properly maintained and any necessary repairs or maintenance is performed before the next season begins. For example, an alert may include the changing of tires configured for summer weather conditions to snow tires configured for snow and icy road conditions. Other examples may include, but are not limited to, ensuring the recreational vehicle's piping system (e.g., waterpipe/plumbing system) is properly winterized and without leakages prior to the vehicle being exposed to freezing temperatures.

As contemplated above, in embodiments, digital twin module 114 may also be configured to generate one or more digital twins 122 and relevant predictions 126 associated with the piping system (e.g., waterpipe system and/or plumbing system) and its various subcomponents (e.g., pump stations, pipe networks, storage tanks, treatment subsystems, etc.). In these embodiments, digital twin module 114 may be configured to manage the various liquids a recreational vehicle may carry and/or utilize (e.g., fuel, oil, drinking water, utility water, and wastewater that may no longer be used for human consumption). As such, recreational vehicle storage tanks configured to store liquids may manage water in its various form, for example black, gray and drinking water. In these embodiments, digital twin module 114 can use the generated digital twin to predict and manage all types of water related infrastructure associated with the recreational vehicle. For example, digital twin module 114 may be configured to simulate and determine water quality, type and/or amount of water contamination, if the water is safe to use for one or more purposes (e.g., safe for human consumption or to water plants), and/or particular water treatments that may be used to treat the water. Digital twin module 114 may also be configured to recommend (e.g., vehicle recommendation report 132 and/or vehicle maintenance plan 130) methods to ensure water is used efficiently throughout the vehicle. In some embodiments, a digital twin associated for water treatment may include one or more characteristics. These characteristics may include, but are not limited to, ensuring the digital twin is hydraulically accurate for both pumped and gravity related waterpipe/plumbing systems, having control logic that may mimic the systems operation, and water quality and process performance information (e.g., via input dataset module 110 and/or Database 108).

In some embodiments, recreational vehicle management system 100 may be configured to use augmented reality (AR) and/or virtual reality (VR). In these embodiments, AR, VR, or a combination thereof may be configured by recreational vehicle management system 100 to provide the user with a realistic view of the recreational vehicle. In such embodiments, the user may view how the recreational vehicle operates and performs in various environments. These embodiments may utilize the information collected and generated by recreational vehicle management system 100 to allow the user to observe how the recreational vehicle may be safely operated and what maintenance may be required after operating the recreational vehicle in different environments and locations. In embodiments, digital twin module 114 may be configured to perform any analysis required to generate the AR/VR environment (e.g., analyze and generate 3-dimensional and 2 dimensional modeling).

In some embodiments, AR and/or VR techniques may be used to provide a user with remote maintenance. While in some embodiments, remote maintenance may allow a person to remotely access the recreational vehicle and perform necessary maintenance (e.g., computer system maintenance), in other embodiments, remote maintenance may provide instruction and supervision for a non-expert user (e.g., via a AR or VR headset) to remotely perform the repair or maintenance themselves. In one example embodiment, a user could receive notice (e.g., recreational vehicle assistant 106) that one or move vehicle components have been identified using digital twin module 114 that should be repaired or replaced via vehicle maintenance plan 130. In this example, a user may use AR and/or VR techniques based off of digital twin module 114 and receive visual and/or auditory instructions (e.g., from a skilled operator in a control room) regarding how the user should perform the particular repair. In some embodiments, the AR/VR environment may be overlayed with the physical recreational vehicle (e.g., portion of the recreational vehicle requiring maintenance). In these embodiments, the AR/VR environment may be configured to respond to the user interacting with the recreational vehicle as the user receives instructions. For example, as a user performs the maintenance the digital twin module 114 (e.g., via data received from data collection devices 112 in real time) may constantly update the AR/VR environment to correspond to the actions performed on the recreational vehicle by the user. In these embodiments, the digital twin module updates in such a way as to seamlessly allow the user to interact with the AR/VR environment while performing the required maintenance. Such instructions may be provided to the user in a variety of ways including, but not limited to, remotely delivered the AR/VR instructions via a third party maintenance based company, automatically generating the AR/VR instruction using digital twin module 114 (e.g., historical repository 120, user manual and/or guides, real-time data collection devices 112, etc.), retrieving pre-loaded AR/VR instructions from database 108 that may be selected when needed. AR/VR based remote maintenance is particularly useful in regards to recreational vehicles, as such vehicles enable users to travel to environments and locations with sparce population where recreational maintenance may be difficult to reach.

In some embodiments, an identified maintenance issue may require more than one person to repair the one or more recreational vehicle components 116. In such embodiments, recreational vehicle management system 100 may be configured in such a way as to produce multiple AR/VR environments based on each particular person's (e.g., user's) point of view and AR/VR instructions specific to each person's intended role in the repair. In embodiments, recreational vehicle management system 100 could configure the digital twin based AR/VR environment to ensure the user or users are able to clearly identify the process of repair. For example, the AR/VR environment may highlight particular recreational vehicle components 116 within the AR/VR environment that are relevant to the user performing a particular step in the repair process. As contemplated herein remote maintenance may often be used to perform maintenance on complex systems of the recreational vehicle. For example, the AR/VR environment may provide the user with the ability to view hidden vehicle components (e.g., hidden wiring) or vehicle components obstructed from view by other, more external vehicle components (e.g., particular waterpipe within the waterpipe system). In other embodiments, recreational vehicle management system 100 may also include remote maintenance instructions regarding other general tasks associated with the recreational vehicle, such as how to connect the recreational vehicle to a power supply, how to operate a hydraulic slide out associated with the recreational vehicle, how to setup and/or dismantle recreational vehicle accessories (e.g., how to set up an awning or canopy), and how to dispose of particular waste associated with the recreational vehicle (e.g., recycling or disposal of liquid contaminants). In some embodiments, remote maintenance instructions may be provided to the user via recreational vehicle assistant 106.

In embodiments, recreational vehicle management system 100 may be configured to interact with an integrated vendor asset governance system. In such systems, not only can each recreational vehicle components 116 be tracked and compiled (e.g., in database 108), but also information associated with each particular recreational vehicle components 116. For example, integrated vendor asset governance system may include documenting data associated with each particular vehicle component such as the following: the impact of the vehicle component, the modification of the vehicle component, each repair that occurs on a vehicle component, a gap in maintenance of the vehicle component, and any updates that may have occurred on the vehicle component.

In embodiments, integrated vendor asset governance system and the associated information may be used (e.g., via recreational vehicle management system 100) to able to determine how each vehicle component modification may impact the recreational vehicle. In embodiments, integrated vendor asset governance system may receive information from recreational vehicle management system 100 to identify and/or govern maintenance gaps of each recreational vehicle components 116. In these embodiments, digital twin module 114 may simulate how each maintenance gap may affect the entire recreational vehicle over a period of time and how such a maintenance gap may result in the possible breakdown of the particular recreational vehicle components 116 and/or the complete failure of the recreational vehicle.

In some embodiments the integrated vendor asset governance system may be based, at least in part, on a blockchain network where each vendor may be an organization in the blockchain network. In such embodiments, the blockchain network may utilize individual chain-code components to identify past and current relevant information associated with one or more recreational vehicle components 116. For example, such relevant information may include, but is not limited to, the recreational vehicle components 116's remaining useful life, repair, alterations, replacement, mishandling of the vehicle component, the variety of past and currently broken vehicle components (e.g., appliances, segments, machinery systems). Such information may be compiled and used to generate documentation that may be used as evidence (e.g., for breach of insurance, breach of contract, breach of rental agreement, etc.), as well as to identifying the correct ownership of the recreational vehicle (e.g., during instances of ownership transfer) and generating an estimated cost of the recreational vehicle (e.g., compiling the condition of the recreational vehicle).

In some embodiments, digital twin module 114 may be used to generate a digital twin reference model that may be used to generate digital twins of other recreational vehicles. For example, digital twin module 114 may utilize the information associated with the management and maintenance of one or more particular recreational vehicles to generate a digital reference model for a different recreational vehicle. For example, digital twin module 114 may use the information associated generating and analyzing a digital twin related to a motorhome to generate a reference model for a fifth wheel trailer.

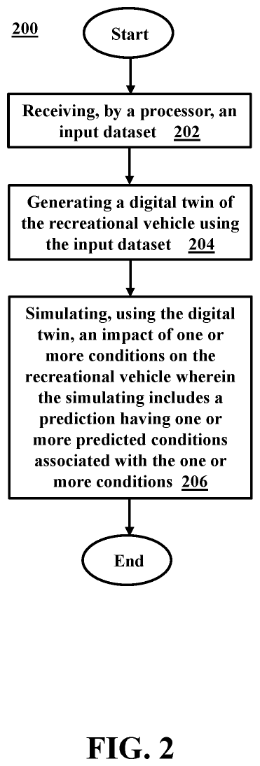

Referring now to FIG. 2, a flowchart illustrating an example method 200 for managing a recreational vehicle, in accordance with embodiments of the present disclosure. In some embodiments, the method 200 may be performed by recreational vehicle management system 100, as referenced in FIG. 1.

In some embodiments, the method 200 begins at operation 202 where the processor receives an input dataset having a plurality of vehicle components and performance factors. The method 200 proceeds to operation 204 where the processor generates a digital twin of the recreational vehicle of interest using, at least in part, the input dataset. The method 200 proceeds to operation 206 where the processor simulates, using the digital twin, an impact of one or more conditions on the vehicle. In embodiments the simulation can include a prediction having one or more predicted conditions associated with the vehicle and conditions. In some embodiments, as depicted, after operation 206 the method 200 may end.

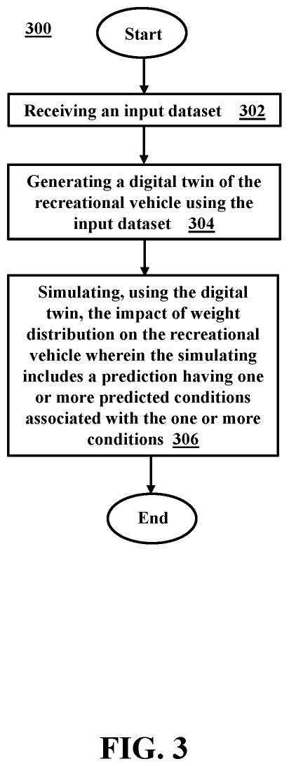

Referring now to FIG. 3, a flowchart illustrating an example method 300 for managing a recreational vehicle, in accordance with embodiments of the present disclosure. In some embodiments, the method 200 may be performed by recreational vehicle management system 100, as referenced in FIG. 1.

In some embodiments, the method 300 begins at operation 302 where the processor receives an input dataset having a plurality of vehicle components and performance factors. The method 300 proceeds to operation 304 where the processor generates a digital twin of the recreational vehicle of interest using, at least in part, the input dataset. The method 300 proceeds to operation 306 where the processor simulates, using the digital twin, the impact of weight distribution on the recreational vehicle wherein the simulating includes a prediction having one or more predicted conditions associated with the one or more conditions. In some embodiments, as depicted, after operation 306 the method 300 may end.

Referring now to FIG. 4, a flowchart illustrating an example method 400 for managing a recreational vehicle, in accordance with embodiments of the present disclosure. In some embodiments, the method 400 may be performed by recreational vehicle management system 100, as referenced in FIG. 1.

In some embodiments, the method 400 begins at operation 402 where the processor receives an input dataset having a plurality of vehicle components and performance factors. The method 400 proceeds to operation 404 where the processor generates a digital twin of the recreational vehicle of interest using, at least in part, the input dataset. The method 400 proceeds to operation 406 where the processor simulates, using the digital twin, to generate an augmented reality environment for remote maintenance. In some embodiments, as depicted, after operation 406 the method 400 may end.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick user platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various user devices through a thin user interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

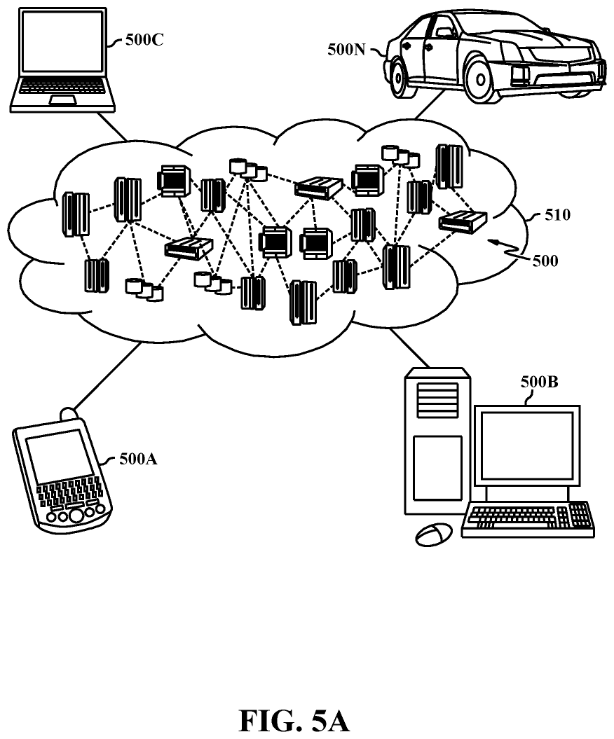

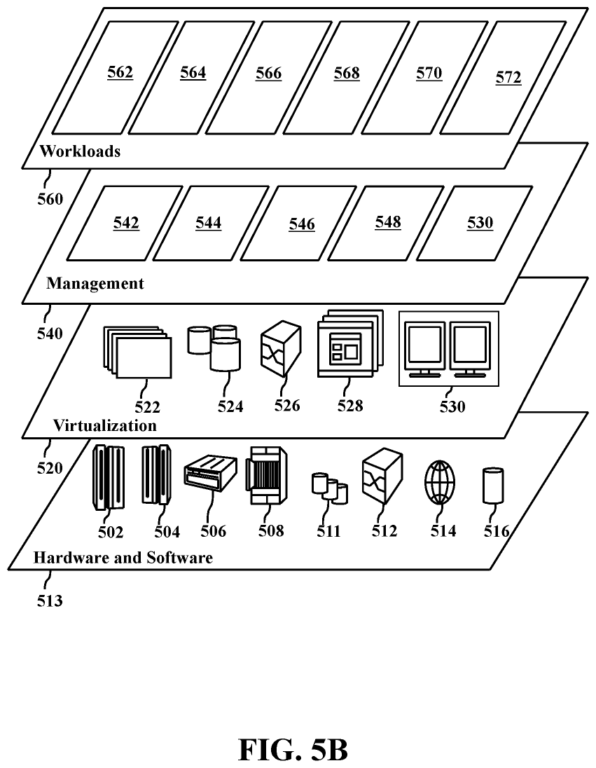

Referring now to FIG. 5A, illustrative cloud computing environment 50010 is depicted. As shown, cloud computing environment 50010 includes one or more cloud computing nodes 500 with which local computing devices used by cloud consumers, such as, for example, personal digital assistant (PDA) or cellular telephone 500A, desktop computer 500B, laptop computer 500C, and/or automobile computer system 500N may communicate. Nodes 500 may communicate with one another. They may be grouped (not shown) physically or virtually, in one or more networks, such as Private, Community, Public, or Hybrid clouds as described hereinabove, or a combination thereof. This allows cloud computing environment 510 to offer infrastructure, platforms and/or software as services for which a cloud consumer does not need to maintain resources on a local computing device. It is understood that the types of computing devices 500A-N shown in FIG. 5A are intended to be illustrative only and that computing nodes 500 and cloud computing 500 and cloud computing environment 510 can communicate with any type of computerized device over any type of network and/or network addressable connection (e.g., using a web browser).

Referring now to FIG. 5B, a set of functional abstraction layers provided by cloud computing environment 510 (FIG. 5A) is shown. It should be understood in advance that the components, layers, and functions shown in FIG. 5B are intended to be illustrative only and embodiments of the disclosure are not limited thereto. As depicted below, the following layers and corresponding functions are provided.

Hardware and software layer 515 includes hardware and software components. Examples of hardware components include: mainframes 502; RISC (Reduced Instruction Set Computer) architecture based servers 504; servers 506; blade servers 508; storage devices 511; and networks and networking components 512. In some embodiments, software components include network application server software 514 and database software 516.

Virtualization layer 520 provides an abstraction layer from which the following examples of virtual entities may be provided: virtual servers 522; virtual storage 524; virtual networks 526, including virtual private networks; virtual applications and operating systems 528; and virtual clients 530.

In one example, management layer 540 may provide the functions described below. Resource provisioning 542 provides dynamic procurement of computing resources and other resources that are utilized to perform tasks within the cloud computing environment. Metering and Pricing 544 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 546 provides access to the cloud computing environment for consumers and system administrators. Service level management 548 provides cloud computing resource allocation and management such that required service levels are met. Service Level Agreement (SLA) planning and fulfillment 550 provide pre-arrangement for, and procurement of, cloud computing resources for which a future requirement is anticipated in accordance with an SLA.

Workloads layer 560 provides examples of functionality for which the cloud computing environment may be utilized. Examples of workloads and functions which may be provided from this layer include: mapping and navigation 562; software development and lifecycle management 564; virtual classroom education delivery 566; data analytics processing 568; transaction processing 570; and proactive vehicle managing 572.

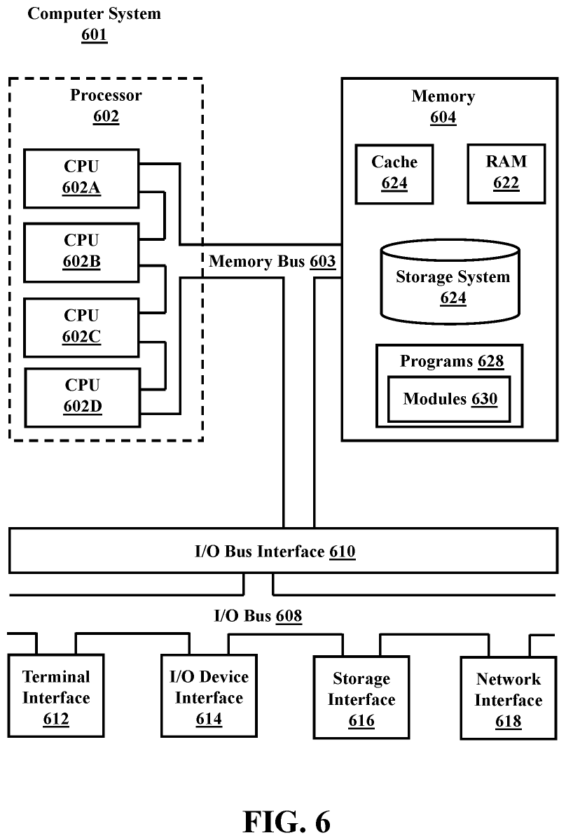

FIG. 6, illustrated is a high-level block diagram of an example computer system 601 that may be used in implementing one or more of the methods, tools, and modules, and any related functions, described herein (e.g., using one or more processor circuits or computer processors of the computer), in accordance with embodiments of the present invention. In some embodiments, the major components of the computer system 601 may comprise one or more Processor 602, a memory subsystem 604, a terminal interface 612, a storage interface 616, an I/O (Input/Output) device interface 614, and a network interface 618, all of which may be communicatively coupled, directly or indirectly, for inter-component communication via a memory bus 603, an I/O bus 608, and an I/O bus interface unit 610.

The computer system 601 may contain one or more general-purpose programmable central processing units (CPUs) 602A, 602B, 602C, and 602D, herein generically referred to as the CPU 602. In some embodiments, the computer system 601 may contain multiple processors typical of a relatively large system; however, in other embodiments the computer system 601 may alternatively be a single CPU system. Each CPU 602 may execute instructions stored in the memory subsystem 604 and may include one or more levels of on-board cache.

System memory 604 may include computer system readable media in the form of volatile memory, such as random access memory (RAM) 622 or cache memory 624. Computer system 601 may further include other removable/non-removable, volatile/non-volatile computer system storage media. By way of example only, storage system 626 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 604 can include flash memory, e.g., a flash memory stick drive or a flash drive. Memory devices can be connected to memory bus 603 by one or more data media interfaces. The memory 604 may include at least one program product having a set (e.g., at least one) of program modules that are configured to carry out the functions of various embodiments.

One or more programs/utilities 628, each having at least one set of program modules 630 may be stored in memory 604. The programs/utilities 628 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 628 and/or program modules 630 generally perform the functions or methodologies of various embodiments.

Although the memory bus 603 is shown in FIG. 6 as a single bus structure providing a direct communication path among the CPUs 602, the memory subsystem 604, and the I/O bus interface 610, the memory bus 603 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 610 and the I/O bus 608 are shown as single respective units, the computer system 601 may, in some embodiments, contain multiple I/O bus interface units 610, multiple I/O buses 608, or both. Further, while multiple I/O interface units are shown, which separate the I/O bus 608 from various communications paths running to the various I/O devices, in other embodiments some or all of the I/O devices may be connected directly to one or more system I/O buses.

In some embodiments, the computer system 601 may be a multi-user mainframe computer system, a single-user system, or a server computer or similar device that has little or no direct user interface, but receives requests from other computer systems (clients). Further, in some embodiments, the computer system 601 may be implemented as a desktop computer, portable computer, laptop or notebook computer, tablet computer, pocket computer, telephone, smartphone, network switches or routers, or any other appropriate type of electronic device.

It is noted that FIG. 6 is intended to depict the representative major components of an exemplary computer system 601. In some embodiments, however, individual components may have greater or lesser complexity than as represented in FIG. 6, components other than or in addition to those shown in FIG. 6 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present invention has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A method for proactive maintenance for a recreational vehicle, the method comprising:
receiving, by a processor, an input dataset, wherein the input dataset is associated with a plurality of vehicle components and one or more performance factors of the recreational vehicle;
generating a digital twin of the recreational vehicle using the input dataset; and
simulating, using the digital twin, an impact of one or more conditions on the recreational vehicle, wherein the simulating includes a prediction having one or more predicted conditions associated with the recreational vehicle.

2. The method of claim 1, wherein the input dataset is received from a real-time data feed connected to one or more of the plurality of vehicle components, and wherein the method further comprises:
identifying the one or more performance factors from the real-time data feed.

3. The method of claim 1, further comprising:
configuring an historical repository of the one or more performance factors, and the plurality of vehicle components, based on an historical dataset.

4. The method of 3, wherein simulating the impact of one or more conditions on the recreational vehicle, further comprises:
analyzing the historical repository to identify the prediction.

5. The method of claim 1, wherein the digital twin of the recreational vehicle includes:
identifying a maintenance issue associated with the one or more vehicle components of the recreational vehicle;
generating an augmented reality (AR) environment of the recreational vehicle, wherein the AR environment is associated with the maintenance issue; and
providing one or more remote maintenance instructions to a user of the recreational vehicle to repair the maintenance issue.

6. The method of claim 5, further comprising:
updating the digital twin after each of the one or more remote maintenance instructions are performed by the user.

7. The method of claim 1, wherein the prediction having the one or more predicted conditions associated with the recreational vehicle includes a recreational vehicle maintenance plan, wherein the recreational vehicle maintenance plan includes one or more mitigating recommendations associated with the one or more predicted conditions.

8. A system for proactive maintenance for a recreational vehicle, the system comprising:
a memory; and
a processor in communication with the memory, the processor being configured to perform operations comprising:
receiving, by a processor, an input dataset, wherein the input dataset is associated with a plurality of vehicle components and one or more performance factors of the recreational vehicle;
generating a digital twin of the recreational vehicle using the input dataset; and
simulating, using the digital twin, an impact of one or more conditions on the recreational vehicle, wherein the simulating includes a prediction having one or more predicted conditions associated with the recreational vehicle.

9. The system of claim 8, wherein the input dataset is received from a real-time data feed connected to one or more of the plurality of vehicle components, and wherein the method further comprises:
identifying the one or more performance factors from the real-time data feed.

10. The system of claim 8, further comprising:
configuring an historical repository of the one or more performance factors, and the plurality of vehicle components, based on an historical dataset.

11. The system of 10, wherein simulating the impact of one or more conditions on the recreational vehicle, further comprises:
analyzing the historical repository to identify the prediction.

12. The system of claim 8, wherein the digital twin of the recreational vehicle further includes:
identifying a maintenance issue associated with the one or more vehicle components of the recreational vehicle;
generating an augmented reality (AR) environment of the recreational vehicle, wherein the AR environment is associated with the maintenance issue; and
providing one or more remote maintenance instructions to a user of the recreational vehicle to repair the maintenance issue.

13. The system of claim 12, further comprising:
updating the digital twin after each of the one or more remote maintenance instructions are performed by the user.

14. The system of claim 8, wherein the prediction having the one or more predicted conditions associated with the recreational vehicle further includes a recreational vehicle maintenance plan, wherein the recreational vehicle maintenance plan includes one or more mitigating recommendations associated with the one or more conditions.

15. A computer program product for proactive maintenance for a recreational vehicle, the computer program product comprising a computer readable storage medium having program instructions embodied therewith, the program instructions executable by a processor to cause the processors to perform a function, the function comprising:
receiving, by a processor, an input dataset, wherein the input dataset is associated with a plurality of vehicle components and one or more performance factors of the recreational vehicle;
generating a digital twin of the recreational vehicle using the input dataset; and
simulating, using the digital twin, an impact of one or more conditions on the recreational vehicle, wherein the simulating includes a prediction having one or more predicted conditions associated with the recreational vehicle.

16. The computer program product of claim 15, wherein the input dataset is received from a real-time data feed connected to one or more of the plurality of vehicle components, and wherein the method further comprises:
identifying the one or more performance factors from the real-time data feed.

17. The computer program product of claim 15, further comprising:
configuring an historical repository of the one or more performance factors, and the plurality of vehicle components, based on an historical dataset.

18. The computer program product of 17, wherein simulating the impact of one or more conditions on the recreational vehicle, further comprises:
analyzing the historical repository to identify the prediction.

19. The computer program product of claim 15, wherein the digital twin of the recreational vehicle further includes:
identifying a maintenance issue associated with the one or more vehicle components of the recreational vehicle;
generating an augmented reality (AR) environment of the recreational vehicle, wherein the AR environment is associated with the maintenance issue; and
providing one or more remote maintenance instructions to a user of the recreational vehicle to repair the maintenance issue.

20. The computer program product of claim 19, further comprising:
updating the digital twin after each of the one or more remote maintenance instructions are performed by the user.
